(19) United States
(12) Patent Application Publication
(10) Pub. No.: US 2024/0203286 A1
(43) Pub. Date: Jun. 20, 2024

(54) FISHING POSTURE RECOGNITION METHOD

(71) Applicant: Shenzhen Bosaidong Technology Co., Ltd., Shenzhen (CN)

(72) Inventors: Huangshen Qu, Shenzhen (CN); Yunting Zhang, Shenzhen (CN); Xiaohui Cui, Shenzhen (CN); Tianshi Cui, Shenzhen (CN)

(21) Appl. No.: 18/230,688

(22) Filed: Aug. 7, 2023

(30) Foreign Application Priority Data
Dec. 19, 2022 (CN) 202211634133.5

(51) Int. Cl. G09B 19/00

(52) U.S. Cl. CPC G09B 19/0038; G01P 15/18

(57) ABSTRACT

Disclosed is a fishing posture recognition method applied to fishing reels, including a three-axis accelerometer and three-axis gyroscope detecting three-axis acceleration and three-axis angular velocity of the fishing reel. And it can prompt the user whether a piercing fish operation is completed based on the three-axis acceleration and the three-axis angular velocity. The present invention can collect the posture information of the fishing reel to obtain the three-axis acceleration and three-axis angular velocity of the fishing reel. It can prompt the users whether the piercing fish operation has been completed based on the detected three-axis acceleration and three-axis angular velocity, so that users who use the fishing reel can get fish situation in real-time, and the bait, fishing line, and braking force can be adjusted according to the fish situation which improving the user experience and lowering the entry threshold for Lure, allowing more people to participate in Lure activities.

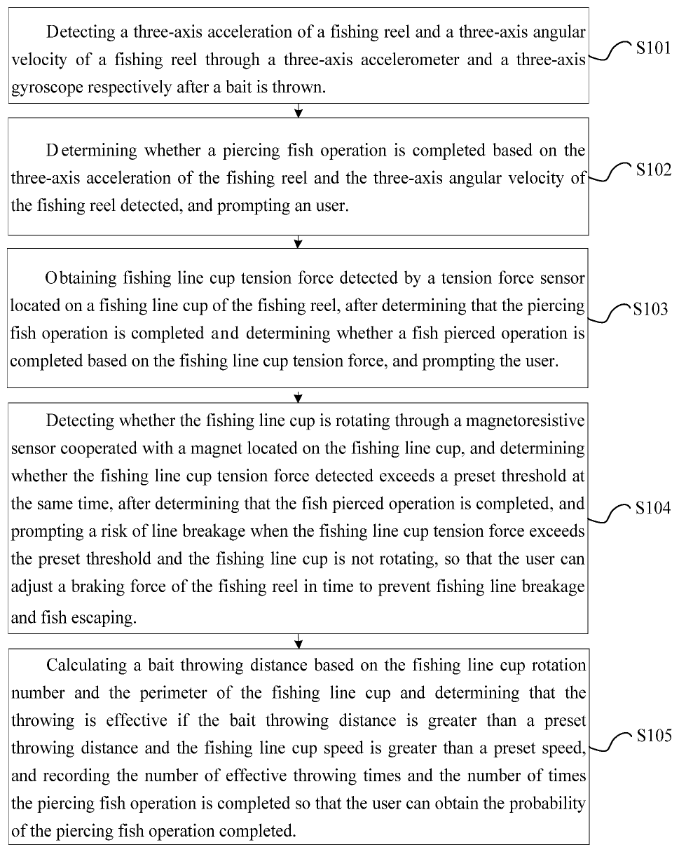

### CROSS REFERENCE TO RELATED APPLICATIONS

The present application is based on Chinese patent application No. 202211634133.5 filed on Dec. 19, 2022, and claims its priority. The entire disclosure of the application is incorporated herein by reference in its entirety.

### TECHNICAL FIELD

The present application relates to the technical field of fishing, and in particular relates to a fishing posture recognition method.

### BACKGROUND

The Lure is a fishing method that requires anglers to reel out and reel in fishing lines repeatedly. As the most environmentally friendly fishing method, it becomes increasingly popular in outdoor fishing activities. Since the anglers need to actively search for the target fish species when lure fishing, they walk around to find various fish species in different water areas and layers. Then, by manipulating the fishing reel and rod, the fake bait simulates the swimming posture of the real bait in the water, so that it can attract the fish to take the bait. The angler can only determine the posture of the lure bait in the water based on experience after the bait is thrown out during the fishing process, and cannot know the fish situation. The angler is unable to adjust the bait and fishing line according to the actual situation, greatly raising the threshold of Lure activities.

### SUMMARY

The objective of the present application is to provide a fishing posture recognition method, which has the advantages of prompting and teaching the users to fish.

To achieve the above objective, the present application provides a fishing posture recognition method applied to a fishing reel, including:
detecting a three-axis acceleration of a fishing reel and a three-axis angular velocity of a fishing reel through a three-axis accelerometer and a three-axis gyroscope respectively after a bait is thrown; and
determining whether a piercing fish operation is completed based on the three-axis acceleration of the fishing reel and the three-axis angular velocity of the fishing reel detected, and prompting a user.

As a further technical solution in the present application, the step of determining whether a piercing fish operation is completed based on the three-axis acceleration of the fishing reel and the three-axis angular velocity of the fishing reel detected, includes:
calculating a rotation angle Ry of the fishing reel on a y-axis based on the three-axis angular velocity of the fishing reel;
determining whether a Z-axis acceleration in the three-axis acceleration of the fishing reel is greater than 4 g, and determining whether the angle Ry is greater than 150°; wherein g is a gravitational acceleration; and
determining that the piercing fish operation is completed when the Z-axis acceleration in the three-axis acceleration is greater than 4 g and the angle Ry is greater than 150°.

As a further technical solution in the present application, after determining whether a Z-axis acceleration in the three-axis acceleration of the fishing reel is greater than 4 g, and determining whether the angle Ry is greater than 150°, the fishing posture recognition method further includes:
calculating rotation angles Rx and Rz of the fishing reel on an x-axis and a z-axis based on the three-axis angular velocity of the fishing reel;
determining whether the angle Rx is within a range of ±10°, and whether the angle Rz is within a range of ±20° when the Z-axis acceleration in the three-axis acceleration is greater than 4 g and the angle Ry is greater than 150°; and
determining that the piercing fish operation is completed when the angle Rx is within a range of ±10°, and the angle Rz is within a range of ±20°.

As a further technical solution in the present application, the fishing posture recognition method further includes:
obtaining fishing line cup tension force detected by a tension force sensor located on a fishing line cup of the fishing reel, after determining that the piercing fish operation is completed; and
determining whether a fish pierced operation is completed based on the fishing line cup tension force, and prompting the user.

As a further technical solution in the present application, the fishing posture recognition method further includes:
detecting whether the fishing line cup is rotating through a magnetoresistive sensor cooperated with a magnet located on the fishing line cup, and determining whether the fishing line cup tension force detected exceeds a preset threshold at the same time, after determining that the fish pierced operation is completed; and
prompting a risk of line breakage when the fishing line cup tension force exceeds the preset threshold and the fishing line cup is not rotating, so that the user can adjust a braking force of the fishing reel in time to prevent fishing line breakage and fish escaping.

As a further technical solution in the present application, after a bait is thrown, the fishing posture recognition method further includes:
detecting whether a fishing line cup is rotating through a magnetoresistive sensor cooperated with a magnet located on the fishing line cup;
obtaining a fishing line cup rotation number and fishing line cup rotation time based on an interrupt signal from the magnetoresistive sensor;
obtaining a fishing line cup rotation speed based on the fishing line cup rotation number and the fishing line cup rotation time;
determining whether the fishing line cup rotation speed is greater than a preset secondary reeling out speed, and if not, determining that a sinking distance of the bait is a secondary reeling out distance; and
recording the secondary reeling out distance.

As a further technical solution in the present application, the fishing posture recognition method further includes:
calculating a bait throwing distance based on the fishing line cup rotation number and the perimeter of the fishing line cup;
determining that the throwing is effective if the bait throwing distance is greater than a preset throwing distance and the fishing line cup speed is greater than a preset speed; and
recording the number of effective throwing times and the number of times the piercing fish operation is completed so that the user can know the probability of the piercing fish operation completed.

As a further technical solution in the present application, the fishing posture recognition method further includes:

determining whether a line breakage occurs based on the fishing line cup rotation number during reeling in and the fishing line cup rotation number during reeling out after reeling in the fishing line and calculating the length of a broken fishing line when determining that a line breakage occurs.

As a further technical solution in the present application, the fishing posture recognition method further includes:

calculating the actual length of fishing line which is reel out after the bait is thrown again based on the fishing line cup rotation number and the length of the broken fishing line, and prompting the user.

As a further technical solution in the present application, the fishing posture recognition method further includes:

detecting a direction angle formed by a current fishing rod and the North Pole through a three-axis magnet meter after determining that the piercing fish operation is completed to identify the throwing direction and prompting the user.

The present application compared with existing technology can collect the posture information of the fishing reel during the fishing process when users use the fishing reel which detects the three-axis acceleration of the fishing reel and the three-axis angular velocity of the fishing reel through a three-axis accelerometer and a three-axis gyroscope. It can determine whether a piercing fish operation has been completed based on the three-axis acceleration of the fishing reel and the three-axis angular velocity of the fishing reel detected, and prompt the user, so that the users who use the fishing reel for fishing can get the fish situation in real-time which improving the user experience and lowering the entry threshold for Lure, allowing more people to participate in Lure activities.

### BRIEF DESCRIPTION OF THE DRAWINGS

The sole FIGURE is a flowchart of an embodiment of the fishing posture recognition method of the present application.

### DETAILED DESCRIPTION

To make the objectives, technical solutions and effect of the present application clearer and more definite, the present application is further described in detail with reference to the accompanying figures and embodiments.

The sole FIGURE is a flowchart of an embodiment of the fishing posture recognition method of the present application. The fishing posture recognition method of the present application is applied to a fishing reel, wherein the fishing posture recognition method includes:

S101, detecting a three-axis acceleration of a fishing reel and a three-axis angular velocity of a fishing reel through a three-axis accelerometer and a three-axis gyroscope respectively after a bait is thrown.

Understandably, the fishing reel follows the movement of a fishing rod when an angler manipulates the fishing rod for fishing and the fishing reel is fixed to the fishing rod. The fishing reel includes a body and a fishing line cup. The fishing line cup rotates to reel out the fishing line during the process of throwing. The three-axis accelerometer, the three-axis gyroscope, and a three-axis magnetometer can be encapsulated together to form a 9-axis sensor, which can be set on the body of the fishing reel to detect the three-axis acceleration of the fishing reel and the three-axis angular velocity of the fishing reel.

S102, determining whether a piercing fish operation is completed based on the three-axis acceleration of the fishing reel and the three-axis angular velocity of the fishing reel detected, and prompting a user.

Specifically, step S102 includes: calculating rotation angles Rx, Ry, and Rz of the fishing reel on an x-axis, a y-axis, and a z-axis based on the three-axis angular velocity and determining whether a Z-axis acceleration in the three-axis acceleration is greater than 4 g, and determining whether the angle Ry is greater than 150°, wherein g is a gravitational acceleration; determining whether the angle Rx is within a range of ±10°, and the angle Rz is within a range of ±20° when the Z-axis acceleration in the three-axis acceleration is greater than 4 g and the angle Ry is greater than 150°; determining that the piercing fish operation is completed when the angle Rx is within a range of ±10°, and the angle Rz is within a range of ±20°.

Understandably, the three-axis gyroscope measures the angular velocity on the three axes, which is the speed of an object rotates. By multiplying the angular velocity with time and performing an integration operation, an angle at which the object rotates can be obtained. In this embodiment, in order to further improve the accuracy of the determination results, the angles Rx, Ry, and Rz of the rotation of the fishing reel on the x-axis, y-axis, and z-axis, as well as the changes in the acceleration of the z-axis measured by the three-axis acceleration, are comprehensively considered to identify the piercing fish operation.

In this step, the user can also be prompted after determining that the piercing fish operation is completed. The user can check the prompts through a corresponding App on an external device, or set up prompt devices on the body of the fishing reel, such as buzzers and/or indicator lights to prompt the user.

Furthermore, the fishing posture recognition method of the present application can further include: detecting a direction angle formed by the current fishing rod and the North Pole through a three-axis magnetometer after determining that the piercing fish operation is completed to identify the throwing direction and then prompting the user. By recording this directional angle, the angler can determine the target direction for the next throw based on this directional angle, which allows the lure bait to fall into the accurate target water area and improves the probability of catching the fish.

S103, obtaining fishing line cup tension force detected by a tension force sensor located on a fishing line cup of the fishing reel, after determining that the piercing fish operation is completed and determining whether a fish pierced operation is completed based on the fishing line cup tension force, and prompting the user.

In this step, after the user completes the piercing fish operation and gets prompted, the user can pull the bait according to the prompts to complete the fish pierced operation.

After the piercing fish operation is completed, since the fish is biting the bait, the fish will pull the fishing line to swim. The tension will be transmitted to the fishing line cup through the fishing line, the fishing line cup will bear a certain tension and the tension sensor located on the fishing line cup can detect the sudden change in tension. After determining that the piercing fish operation is completed, combined with the tension detected by the tension sensor, if a sudden change is detected in tension, it can be determined that the fish pierced operation is completed, and the user can be prompted to reel in the fishing line.

S104, detecting whether the fishing line cup is rotating through a magnetoresistive sensor cooperated with a magnet located on the fishing line cup and determining whether the fishing line cup tension force detected exceeds a preset threshold at the same time, after determining that the fish pierced operation is completed, and prompting a risk of line breakage when the fishing line cup tension force exceeds the preset threshold and the fishing line cup is not rotating.

In this step, detecting whether the fishing line cup is rotating through a magnetoresistive sensor cooperated with a magnet where the magnet can be located on the fishing line cup, while the magnetoresistive sensor can be located on the body of the fishing reel and be closed to the magnet to sense the magnet when it follows the rotation of the fishing line cup and an interrupt signal will be produced when the magnet passes through and is sensed by the magnetoresistive sensor.

In the present application, if the fishing line cup tension force detected by the tension sensor exceeds the preset threshold which is the upper limit and the magnetoresistive sensor fails to detect the rotation of the fishing line cup when the user controls the fish after determining that the fish pierced operation is completed, a braking force of the fishing reel is excessive. The user can be prompted through a prompt device or an external device app to indicate that the braking force on the fishing reel is excessive at this time and there is a risk of fishing line breakage. It is necessary to adjust the braking force of the fishing reel in time to prevent fishing line breakage and fish escaping.

S105, calculating and obtaining a bait throwing distance based on the fishing line cup rotation number and the perimeter of the fishing line cup; determining that the throwing is effective if the bait throwing distance is greater than a preset throwing distance and the fishing line cup speed is greater than a preset speed, and recording the number of effective throwing times and the number of times the piercing fish operation is completed so that the user can know the probability of the piercing fish operation completed.

In the present application, the fishing line cup rotation number and the fishing line cup rotation time can be obtained based on the number of interrupt signals from the magnetoresistive sensor and the time interval between each signal. In this step, the user can obtain the hit rate during the fishing process based on the number of effective throwing times and the number of times the piercing fish operation is completed.

In some other embodiments, it can also obtain the fishing line cup rotation number and the fishing line cup rotation time based on the interrupt signals from the magnetoresistive sensor after the bait is thrown. Therefore, a fishing line cup rotation speed can be obtained based on the fishing line cup rotation number and the fishing line cup rotation time and determine whether the fishing line cup rotation speed is greater than a preset secondary reeling out speed. If not, a sinking distance of the bait is determined as a secondary reeling out distance and recorded, wherein the secondary reeling out speed can be preset through the app. When the fishing line cup rotation speed is less than or equal to the preset secondary reeling out speed, the fishing reel will proceed with a secondary reeling out, and the sinking distance of the bait is the secondary reeling out distance, which can determine the depth of the bait in the water layer.

Furthermore, the fishing posture recognition method of the present application can further include: determining whether a line breakage occurs based on the fishing line cup rotation number during reeling in and the fishing line cup rotation number during reeling out after reeling in the fishing line and calculating the length of the broken fishing line when determining that the line breakage occurs; preferably, calculating the actual length of fishing line reeling out after the bait is thrown again based on the fishing line cup rotation number and the length of the broken fishing line, and prompting the user, wherein the length of the fishing line reeling out when throwing again is obtained based on the fishing line cup rotation number when reeling out, and the actual length of the fishing line reeling out can be calculated by subtracting the length of the broken fishing line from the length of the fishing line reeling out when throwing again. The user can obtain the actual remaining length of the fishing line to ensure that the remaining length of the fishing line is enough for the bait to fall into the target water area during the subsequent throwing process.

Understandably, the users can set the rod length, sequence number of fishing line, fishing line material, fishing rod hardness, lure type, and the like through the app by connecting to a mobile phone or other external devices through Bluetooth with a Soc Bluetooth chip when the first connection is activated. Meanwhile, a line capacity can be synchronized to the phone, and the app displays an appropriate line capacity to avoid situations of fishing line reeling excessively and insufficiently.

To sum up, the present application can collect the posture information of the fishing reel during the fishing process when users use the fishing reel which detects the three-axis acceleration of the fishing reel and the three-axis angular velocity of the fishing reel through a three-axis accelerometer and a three-axis gyroscope. It can also detect the bait throwing distance, fishing line cup tension, and bait sinking distance, and can be sent to the corresponding app of external devices for users to check. It can also determine the fish situation based on the above data, and it can prompt users to adjust the fishing line, bait, or braking force according to the actual situation. Additionally, users can use the app to conduct data review in the later stage, so as to learn about the advantages and disadvantages of the current fishing process, which improves the user experience, and also lower the entry threshold for Lure, allowing more people to participate in Lure activities.

The above are merely the preferred embodiments of the present application, but the scope of protection of the present application is not limited thereto. It should be understood that those of ordinary skilled in the art can make modifications or variations in light of the above description, and all such modifications and variations should fall within the scope of the appended claims of the present application.

What is claimed is:

1. A fishing posture recognition method, applied to a fishing reel, comprising:
detecting a three-axis acceleration of a fishing reel and a three-axis angular velocity of a fishing reel through a three-axis accelerometer and a three-axis gyroscope respectively after a bait is thrown; and
determining whether a piercing fish operation is completed based on the three-axis acceleration of the fishing reel and the three-axis angular velocity of the fishing reel detected, and prompting a user.

2. The fishing posture recognition method according to claim 1, wherein the step of determining whether a piercing fish operation is completed based on the three-axis acceleration of the fishing reel and the three-axis angular velocity of the fishing reel detected, comprising:
calculating a rotation angle Ry of the fishing reel on a y-axis based on the three-axis angular velocity of the fishing reel;
determining whether a Z-axis acceleration in the three-axis acceleration of the fishing reel is greater than 4 g, and determining whether the angle Ry is greater than 150°; wherein g is a gravitational acceleration; and
determining that the piercing fish operation is completed when the Z-axis acceleration in the three-axis acceleration is greater than 4 g and the angle Ry is greater than 150°.

3. The fishing posture recognition method according to claim 2, wherein after determining whether a Z-axis acceleration in the three-axis acceleration of the fishing reel is greater than 4 g, and determining whether the angle Ry is greater than 150°, further comprising:
calculating rotation angles Rx and Rz of the fishing reel on an x-axis and a z-axis based on the three-axis angular velocity of the fishing reel;
determining whether the angle Rx is within a range of ±10°, and whether the angle Rz is within a range of ±20° when the Z-axis acceleration in the three-axis acceleration is greater than 4 g and the angle Ry is greater than 150°; and
determining that the piercing fish operation is completed when the angle Rx is within a range of ±10°, and the angle Rz is within a range of ±20°.

4. The fishing posture recognition method according to claim 1, further comprising:
obtaining fishing line cup tension force detected by a tension force sensor located on a fishing line cup of the fishing reel, after determining that the piercing fish operation is completed; and
determining whether a fish pierced operation is completed based on the fishing line cup tension force, and prompting the user.

5. The fishing posture recognition method according to claim 4, further comprising:
detecting whether the fishing line cup is rotating through a magnetoresistive sensor cooperated with a magnet located on the fishing line cup, and determining whether the fishing line cup tension force detected exceeds a preset threshold at the same time, after determining that the fish pierced operation is completed; and
prompting a risk of line breakage when the fishing line cup tension force exceeds the preset threshold and the fishing line cup is not rotating, so that the user can adjust a braking force of the fishing reel in time to prevent fishing line breakage and fish escaping.

6. The fishing posture recognition method according to claim 1, wherein after a bait is thrown, further comprising:
detecting whether a fishing line cup is rotating through a magnetoresistive sensor cooperated with a magnet located on the fishing line cup;
obtaining a fishing line cup rotation number and fishing line cup rotation time based on an interrupt signal from the magnetoresistive sensor;
obtaining a fishing line cup rotation speed based on the fishing line cup rotation number and the fishing line cup rotation time;
determining whether the fishing line cup rotation speed is greater than a preset secondary reeling out speed, and if not, determining that a sinking distance of the bait is a secondary reeling out distance; and
recording the secondary reeling out distance.

7. The fishing posture recognition method according to claim 6, further comprising:
calculating a bait throwing distance based on the fishing line cup rotation number and the perimeter of the fishing line cup;
determining that the throwing is effective if the bait throwing distance is greater than a preset throwing distance and the fishing line cup speed is greater than a preset speed; and
recording the number of effective throwing times and the number of times the piercing fish operation is completed so that the user can obtain the probability of the piercing fish operation completed.

8. The fishing posture recognition method according to claim 6, further comprising:
determining whether a line breakage occurs based on the fishing line cup rotation number during reeling in and the fishing line cup rotation number during reeling out after reeling in the fishing line and calculating the length of a broken fishing line when determining that a line breakage occurs.

9. The fishing posture recognition method according to claim 8, further comprising:
calculating the actual length of fishing line which is reel out after the bait is thrown again based on the fishing line cup rotation number and the length of the broken fishing line, and prompting the user.

10. The fishing posture recognition method according to claim 1, further comprising:
detecting a direction angle formed by a current fishing rod and the North Pole through a three-axis magnet meter after determining that the piercing fish operation is completed to identify the throwing direction and prompting the user.
